(19) United States
(12) Patent Application Publication
(10) Pub. No.: US 2025/0277627 A1
(43) Pub. Date: Sep. 4, 2025

(54) SAGGER ALIGNMENT STRUCTURE FOR HEAT TREATMENT DEVICE

(71) Applicant: Hanwha Momentum Co., Ltd., Seongnam-si (KR)

(72) Inventors: Yong Soo KIM, Seoul (KR); Dong Woo LEE, Seoul (KR)

(73) Assignee: Hanwha Momentum Co., Ltd., Seongnam-si (KR)

(21) Appl. No.: 19/210,374

(22) Filed: May 16, 2025

Related U.S. Application Data
(63) Continuation of application No. PCT/KR2023/020012, filed on Dec. 6, 2023.

(30) Foreign Application Priority Data
Dec. 8, 2022 (KR) 10-2022-0170522

(51) Int. Cl. F27D 3/12; B65D 67/02; F27D 3/00; F27D 5/00

(52) U.S. Cl. CPC F27D 3/12; B65D 67/02; F27D 5/0012; F27D 2003/0003; F27D 2003/0013; F27D 2003/0042

(57) ABSTRACT

A sagger alignment structure includes: a first clip configured to connect at least one pair of saggers in a state in which sides of the at least one pair of saggers face each other, where the first clip includes: a first clip body; first clip sides bent from opposite sides of the first clip body; and a first insertion space between the first clip sides and configured to accommodate the sides of the at least one pair of saggers, and where the first clip body comprises a first opening that defines a through hole through the first clip body.

### CROSS-REFERENCE TO RELATED APPLICATION(S)

This application is a continuation of International Application No. PCT/KR2023/020012, filed on Dec. 6, 2023, in the Korean Intellectual Property Receiving Office, which is based on and claims priority to Korean Patent Application No. 10-2022-0170522, filed on Dec. 8, 2022, in the Korean Intellectual Property Office, the disclosures of which are incorporated by reference herein in their entireties.

### BACKGROUND

### 1. Field

The present disclosure relates to a sagger alignment structure that connects saggers placed on a roller provided inside a heat treatment device, and more particularly, to a sagger alignment structure for a heat treatment device to prevent saggers from being misaligned and to maintain an aligned state when the saggers are transferred by a roller.

### 2. Description of Related Art

Generally, a heat treatment device is a device used for improving the properties of a metal or non-metallic material by applying high temperature heat to the metal or non-metallic material, and there are various types of heat treatment devices using different heating methods.

A dual-axis hearth type heat treatment device may be configured to include a heating zone that heats a material from room temperature to about 1000° C., a maintenance zone that maintains the material heated in the heating zone at a high temperature, and a cooling zone that cools the material after heat treatment.

As the size of the heat treatment device (the width and length of the equipment) increases, the misalignment of saggers discharged through an exit area of the heat treatment device may increase.

Thus, there is a growing need for an alignment device to transport saggers, which are powder containers discharged in various forms of irregular arrangements, in a stably aligned state.

### SUMMARY

Provided is a sagger alignment structure that is configured to connect saggers introduced inside a heat treatment device so that the saggers are transported in a condition without being misaligned during transportation.

Further, provided is a sagger alignment structure, which is arranged inside a furnace body for heat-treating a material and is configured to connect saggers, which contain a material, so as to maintain an alignment when the saggers are transported.

According to an aspect of the disclosure, a sagger alignment structure may include: a first clip configured to connect at least one pair of saggers in a state in which sides of the at least one pair of saggers face each other, where the first clip includes: a first clip body; first clip sides bent from opposite sides of the first clip body; and a first insertion space between the first clip sides and configured to accommodate the sides of the at least one pair of saggers, and where the first clip body comprises a first opening that defines a through hole through the first clip body.

The first clip sides may each include a first inclined surface on an outer surface thereof, the first inclined surface being inclined inwardly such that a thickness decreases toward an end thereof.

A sagger assembly includes the at least one pair of saggers connected by the first clip in the state in which the sides of the at least one pair of saggers face each other, where the sagger alignment structure may further include a second clip configured to connect at least one pair of the sagger assemblies, where the second clip includes: a second clip body; second clip sides bent from opposite sides of the second clip body; an intermediate insertion member between the second clip sides and configured to fit into a gap between the at least one pair of the sagger assemblies; and a second insertion space between the second clip sides and the intermediate insertion member, and configured to accommodate sides of the at least one pair of the sagger assemblies, and where the second clip body includes a second opening that defines a through hole through the second clip body.

The intermediate insertion member may be between the second clip sides only on ends of the second clip such that the second opening is not blocked.

The second clip sides may each include a second inclined surface on an outer surface thereof, the second inclined surface being inclined inwardly such that a thickness decreases toward an end thereof.

Concave portions may be formed on the sides of the at least one pair of saggers, where the first clip is configured to fit into the concave portions of the at least one pair of saggers so as not to protrude from an uppermost side of the at least one pair of saggers.

Concave portions may be formed on the sides of the at least one pair of the sagger assemblies, where the second clip is configured to fit into the concave portions of the at least one pair of the sagger assemblies so as not to protrude from an uppermost side of the at least one pair of the sagger assemblies.

A sagger assembly may include the at least one pair of saggers connected by the first clip in the state in which the sides of the at least one pair of saggers face each other, where the sagger alignment structure further includes a second clip configured to connect at least one pair of the sagger assemblies.

The first clip may be configured to connect the at least one pair of saggers in a contact state in which the sides of the at least one pair of saggers are in contact with each other, to form a sagger assembly, where the sagger alignment structure further includes a second clip configured to connect at least one pair of the sagger assemblies at a gap between the at least one pair of the sagger assemblies, the second clip being configured to maintain the at least one pair of the sagger assemblies in at least one line in a first direction.

According to an aspect of the disclosure, a heat treatment system may include: a plurality of saggers configured to contain a material for heat treatment; a furnace body in which the plurality of saggers are provided and including a plurality of rollers configured to transport the plurality of saggers, the furnace body being configured to perform a heat treatment on the material contained in the plurality of saggers; and a sagger alignment structure configured to connect at least some of the plurality of saggers being transported by the plurality of rollers, where the sagger alignment structure includes: a first clip configured to connect, among the plurality of saggers, at least one pair of saggers in a state in which sides of the at least one pair of saggers face each other, where the first clip includes: a first clip body; first clip sides bent from opposite sides of the first clip body; and a first insertion space between the first clip sides and configured to accommodate the sides of the at least one pair of saggers, and where the first clip body includes a first opening that defines a through hole through the first clip body.

A sagger assembly may include the at least one pair of saggers connected by the first clip in the state in which the sides of the at least one pair of saggers face each other, the at least one pair of saggers being separated by a gap in a first direction, where a plurality of the sagger assemblies are provided in rows in the first direction along a width direction of the furnace body, inside the furnace body, where the sagger alignment structure further includes a second clip configured to connect at least one pair of the sagger assemblies, where the second clip includes: a second clip body; second clip sides bent from opposite sides of the second clip body; an intermediate insertion member between the second clip sides and configured to fit into a gap between the at least one pair of the sagger assemblies; and a second insertion space between the second clip sides and the intermediate insertion member, and configured to accommodate sides of the at least one pair of the sagger assemblies, and where the second clip body includes a second opening that defines a through hole through the second clip body.

According to an aspect of the disclosure, a heat treatment system may include: a plurality of saggers configured to contain a material for heat treatment; a furnace body in which the plurality of saggers are provided and including a plurality of rollers configured to transport the plurality of saggers, the furnace body being configured to perform a heat treatment on the material contained in the plurality of saggers; and a sagger alignment structure configured to connect at least some of the plurality of saggers being transported by the plurality of rollers, where the sagger alignment structure includes: a first clip configured to connect, among the plurality of saggers, at least one pair of saggers in a state in which sides of the at least one pair of saggers face each other to form a sagger assembly; and a second clip configured to connect at least one pair of the sagger assemblies, and where a gap between the sagger assemblies is greater than a gap between the at least one pair of saggers.

The first clip may include: a first clip body including a first opening that defines a through hole; first clip sides bent from opposite sides of the first clip body; and a first insertion space between the first clip sides and configured to accommodate the sides of the at least one pair of saggers, and where the second clip includes: a second clip body including a second opening that defines a through hole; second clip sides bent from opposite sides of the second clip body; an intermediate insertion member between the second clip sides and configured to fit into the gap between the at least one pair of the sagger assemblies; and a second insertion space between the second clip sides and the intermediate insertion member, and configured to accommodate sides of the at least one pair of the sagger assemblies.

A width of the first opening may correspond to the gap between the at least one pair of saggers, where a width of the second opening corresponds between the gap between the sagger assemblies.

A plurality of the sagger assemblies may be provided at intervals in a first direction along a width direction of the furnace body, and where the second clip is connected to the gap between the sagger assemblies, the second clip being configured to maintain an alignment of the plurality of the sagger assemblies provided along the first direction.

The plurality of the sagger assemblies provided at intervals along the first direction may each include at least one sagger assembly stacked thereon to form a column.

Each of the plurality of saggers may include concave portions on sides thereof, the concave portions being recessed from uppermost side of the plurality of saggers, where the first clip is configured to fit into the concave portions of the at least one pair of saggers so as not to protrude from the uppermost side of the at least one pair of saggers, and where the second clip is configured to fit into the concave portions of the at least one pair of the sagger assemblies so as not to protrude from an upper most side of the at least one pair of the sagger assemblies.

At least one side supply pipe may be installed in a side of the furnace body, where a number of the at least one side supply pipe is equal to or less than a number of sagger assemblies stacked in the column.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a perspective view showing an example of a state in which a sagger alignment structure is assembled to a sagger, according to an embodiment;

FIG. 2 is a perspective view of a first clip of a sagger alignment structure, according to an embodiment;

FIG. 3 is a perspective view of a second clip of a sagger alignment structure, according to an embodiment;

FIG. 4 is a cross-sectional view showing a state in which a side of a sagger is fitted into a first clip according to an embodiment;

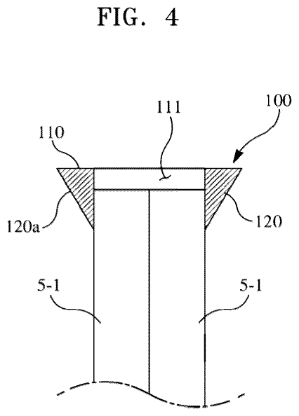

FIG. 5 is a cross-sectional view showing a state in which a side of a sagger is fitted into a second clip, according to an embodiment;

FIG. 6 is a view showing a state in which a first clip and a second clip are fitted into saggers stacked in a plurality of rows and columns, according to an embodiment; and

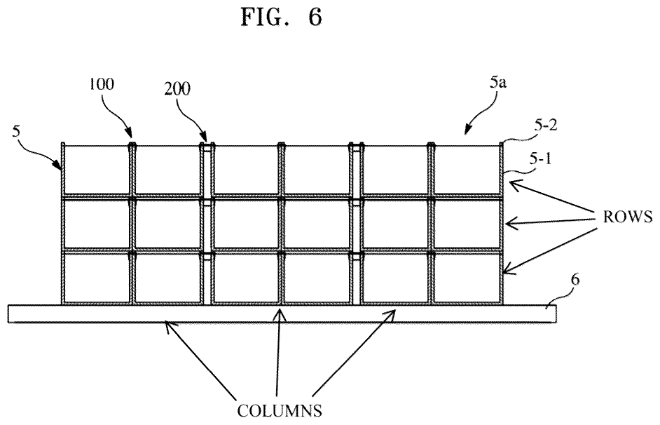

FIG. 7 is a schematic cross-sectional view showing a state in which a sagger alignment structure is inserted into a furnace body of a heat treatment device, according to an embodiment.

### DETAILED DESCRIPTION

Hereinafter, embodiments of the present disclosure will be described in detail with reference to the attached drawings. However, the embodiments described herein are examples, and the disclosure is not limited to the embodiments described and may be implemented in various forms. At least one or more of the components between the embodiments may be selectively combined and/or substituted within the scope of the disclosure.

In addition, terms of the embodiments of the present disclosure may be interpreted as having a meaning that may be generally understood by a person having ordinary knowledge unless specifically defined, and terms that are commonly used may be interpreted in consideration of the contextual meaning of the related technology.

In addition, the terms of the embodiments of the present disclosure are for the purpose of describing the embodiments and do not limit the present disclosure. Singular forms may be interpreted as plural referents unless otherwise stated in the phrase.

In addition, in the components of the embodiments of the present disclosure, terms such as first, second, third, or A, B, C may be used, and these terms are only for distinguishing one component from another component and do not limit the components in terms of order, sequence, or importance.

In addition, in the embodiments of the present disclosure, when one component is described as being “connected,” “coupled,” or “joined” to another component, it may mean not only that one component is directly connected, coupled, or joined to the other component, but also that one component is indirectly connected, coupled, or joined thereto by another component between the two components.

In addition, in the embodiments of the present disclosure, when one component is arranged, formed, or positioned up or down or above or below another component, it may mean that one component is directly or indirectly arranged, formed, or positioned on the other component. The expressions for up or down or above or below may mean not only the upward direction but also the downward direction with respect to one component.

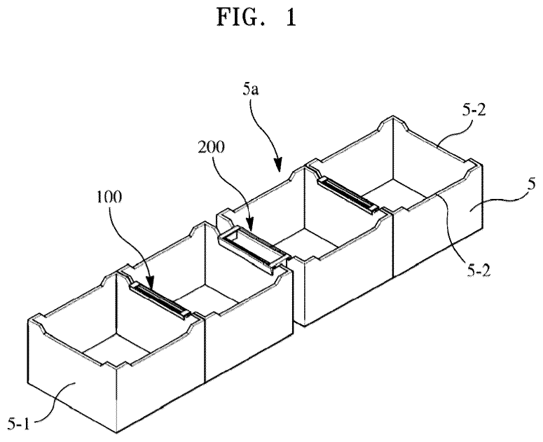

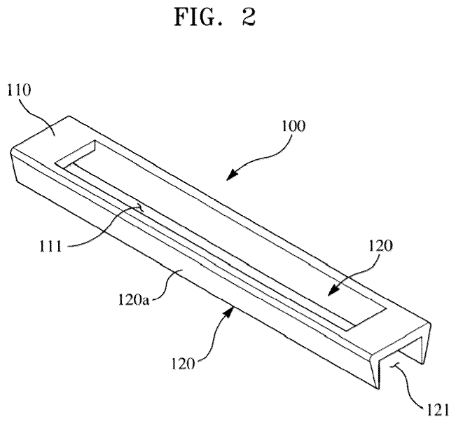

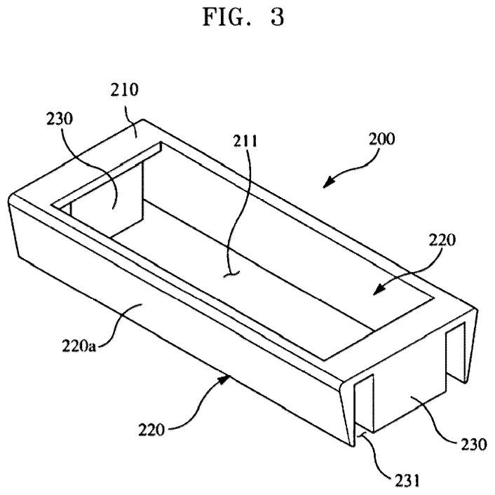

FIG. 1 is a perspective view showing an example of a state in which a sagger alignment structure is assembled to a sagger according to an embodiment, FIG. 2 is a perspective view of a first clip of the sagger alignment structure according to an embodiment, and FIG. 3 is a perspective view of a second clip of the sagger alignment structure according to an embodiment.

Referring to FIGS. 1 to 3, a sagger alignment structure according to an embodiment may include a first clip 100 connected between a plurality of adjacent saggers 5, and a second clip 200 connected at a gap between a plurality of sagger assemblies 5a.

For example, the sagger alignment structure according to an embodiment may be introduced and transported inside a heat treatment device to heat-treat (fire) the saggers 5 including a material (e.g., a secondary battery cathode active material) at high temperature.

A firing process using the heat treatment device may include a method of first putting a powdered and well-mixed precursor into a porous ceramic container, such as a sagger, and then synthesizing a cathode active material in a firing furnace under a high-temperature atmosphere. Because the particle size, distribution, and crustal structure of obtained cathode active material may vary depending on the temperature, atmosphere gas, and synthesis time in the firing furnace, the temperature distribution inside the firing furnace and the control of the flow state of a reaction gas are important.

Cathode active materials such as lithium cobalt oxide (LiCoO₂) may be easy to synthesize, have a gentle potential change, and have excellent conductivity, and thus may be used in secondary batteries.

Therefore, the sagger 5 may be referred to as a heat treatment container for heat-treating a material that includes a secondary battery processing material.

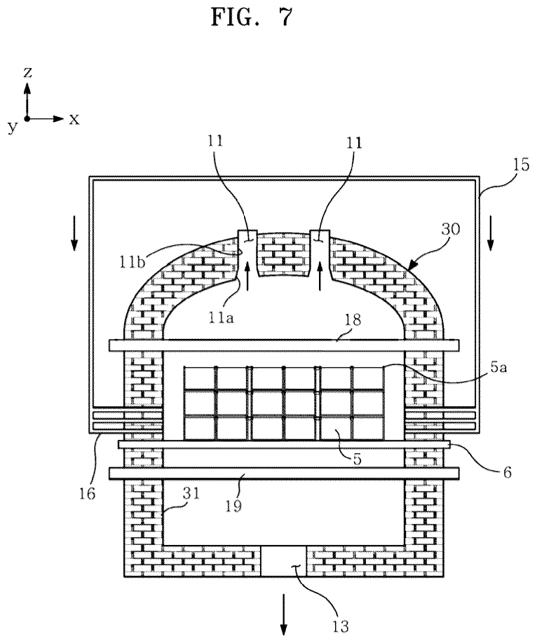

Referring to FIG. 7, the heat treatment device may include a furnace body 30 having a space of a predetermined size for introducing the sagger 5.

A roller 6 for transporting the material may be provided inside the furnace body 30, the transport speed of the material may be easily adjusted, and heat treatment may be uniformly performed regardless of the front, back, top, or bottom of the material.

In addition, the uppermost surface inside of the furnace body 30 may be formed as a flat surface or a curved surface. For example, when the uppermost surface is formed as a curved surface as in an embodiment, the exhaust characteristics of fluid may be improved. That is, the occurrence of turbulence, vortex, or other phenomenon during fluid flow may be prevented, and the residence time of the fluid for heat treatment and the smooth fluid flow characteristics may be secured.

A plurality of upper discharge pipes 11 may be formed in an upper portion of the furnace body 30, and a lower discharge pipe 13 may be formed in a lower portion of the furnace body 30.

Each of the upper discharge pipes 11 may communicate with the inside of the furnace body 30 and may include an inclined first surface 11a, and a second surface 11b whose width in a first direction (the x-axis direction) becomes constant from the first surface 11a towards the upper outer surface of the furnace body 30 in a third direction (the z-axis direction). In addition, the height of the first surface 11a may be less than the height of the second surface 11b based on the third direction, that is, a height direction (the z-axis direction). For example, the height of the first surface 11a may be set to be 50% or less than the height of the second surface 11b.

The plurality of upper discharge pipes 11 each having the inclined first surface 11a are provided at intervals in the first direction (the x-axis direction) that is the width direction of the furnace body 30. Thus, when the fluid inside the furnace body 30, that is the atmospheric gas, is discharged, a rapid change in the flow rate may be controlled, so that the atmospheric gas supplied inside the furnace body 30 may be stably flowed, and accordingly, a material inside the sagger 5 introduced into the furnace body 30 may receive an improved heat-treatment. In addition, the gas distribution inside the furnace body 30 may become uniform, and a temperature deviation may be reduced. The internal space of the furnace body 30 through which the material flows may be expanded by improving the uniformity of the gas distribution and reducing the temperature deviation. Therefore, a larger number of saggers may be loaded and transported using the expanded internal space of the furnace body 30.

The lower discharge pipe 13 may be formed at a lower position than the material located inside the furnace body 30.

In addition, the lower discharge pipe 13 may be formed at a lower position than a support base for supporting the material inside the furnace body 30. The support base may include a roller 6 for transporting the material.

Carbon dioxide, which is heavier than air, may descend inside the furnace body 30 and be discharged to the outside through the lower discharge pipe 13. According to the lower discharge pipe 13 through which the carbon dioxide is discharged, the partial pressure of the carbon dioxide inside the furnace body 30 may be lowered.

In order for the partial pressure of the carbon dioxide inside the furnace body 30 to be uniform, the lower discharge pipe 13 may be formed at the center of the bottom of the furnace. When the material is transported in a second direction, which is the y-axis direction, the lower discharge pipe 13 may be formed at the center of the furnace body 30 in the first direction.

In other words, the lower discharge pipe 13 may be arranged at the center of the bottom surface inside the furnace body 30 based on the first direction.

The sagger 5 may be inserted into the furnace body 30 with the material stored therein. The sagger may be formed to have a special structure so that the chemical reaction of each material is not limited due to saggers that are stacked in multiple layers.

A reaction gas such as oxygen or air injected into the furnace body 30 may contact the material through an opening formed in the sagger 5 and may cause a chemical reaction.

The plurality of upper discharge pipes 11 may be formed on the ceiling surface of the furnace body 30, and the lower discharge pipe 13 and a lower supply pipe may be formed on the bottom surface of the furnace body 30.

In addition, a plurality of side supply pipes 16 may be formed on sides of the furnace body 30.

The side supply pipes 16 may be arranged at positions set on the sides. For example, based on the first direction (the x-axis direction), the side supply pipes 16 may each be arranged in an area corresponding to the sagger 5 and may be arranged in an area not corresponding to the roller 6.

In addition, the plurality of side supply pipes 16 may be provided in the third direction in proportion to the saggers 5 that are stacked in multiple layers in the third direction (the z-axis direction). That is, for example, when the number of layers in which the saggers 5 are stacked is three, three side supply pipes 16 may be arranged to be apart from each other in proportion to the number of layers.

An upper heater 18 may be arranged at a higher position than the sagger 5 that is transported by the roller 6, and a lower heater 19 may be arranged to be apart from a lower portion of the roller 6.

The plurality of side supply pipes 16 may be connected to a side supply connection pipe 15 so that high-temperature atmospheric gas may be supplied. Therefore, the side supply connection pipe 15 may be connected to a gas supply source to which the atmospheric gas is supplied, and may receive the atmospheric gas.

The saggers 5 may be adjacently arranged as a plurality of rows in the first direction (the width direction of the furnace) corresponding to the x-axis direction, and may be transported in a state in which the saggers 5 are stacked and forming columns in the third direction (the height direction of the furnace) corresponding to the z-axis direction. In other words, the first direction may be a direction in which the saggers 5 are arranged in rows, and the third direction may be a direction in which the saggers 5 are stacked in columns.

When the saggers 5 are arranged in a plurality of columns and rows, as the transport distance of the saggers 5 increases, a good alignment state of the saggers 5 may not be maintained. In addition, in the above case, the temperature uniformity characteristics inside the furnace may deteriorate, and a temperature deviation may occur according to areas in the first to third directions. In this case, thermal energies respectively provided to the plurality of saggers 5 may be different, and this may cause a problem in which the properties of the materials provided inside the saggers 5 become different from each other.

Therefore, according to an embodiment, when the first direction (the x-axis direction), which is the width direction of the furnace body 30, is referred to as a row direction and the third direction (the z-axis direction), which is the height direction of the furnace body 30, is referred to as a column direction, the saggers 5 may be arranged in various numbers of rows and columns.

In this case, some of the plurality of saggers 5 facing each other in the first direction (the x-axis direction) may contact each other in the first direction to form a sagger unit 5a, and a plurality of sagger units 5a may be provided at intervals in the row direction, which corresponds to the first direction.

In addition, the sagger units 5a may be provided in a plurality of rows stacked in the column direction corresponding to the third direction. That is, the sagger unit 5a may have at least one row in the column direction and be arranged in plurality columns with spacing in the row direction.

When n number of saggers 5 are all apart from each other in the row direction (the first direction), the length of the furnace body 30 in the first direction increases, and conversely, when n number of saggers 5 are all in contact with each other in the first direction, the alignment of the saggers 5 may be disturbed when the saggers 5 are transported by the rotation of the roller 6. When the saggers 5, being arranged in the plurality of rows and columns, are all in contact with each other and transported, the flow characteristics of the atmosphere inside the furnace may deteriorate. In addition, in the above case, the saggers 5 may be more concentrated in a central area of the roller 6, which may aggravate the sagging of the roller 6, and the friction between the saggers 5 may increase, which may disturb the alignment.

For example, 2*3 saggers (2 saggers in the x-axis direction (the row direction) and 3 saggers in the z-axis direction (the column direction)) may be stacked in the sagger unit 5a, and a plurality of sagger units 5a may be arranged to be apart from each other.

For example, on the roller 6, a first sagger unit and a second sagger unit may be arranged adjacent to inner side walls 31 at both sides of the furnace, and a third sagger unit may be arranged between the first sagger unit and the second sagger unit. In this case, when the plurality of sagger units 5a are provided to be all in contact with each other without being apart from each other in the first direction (the x-axis direction), the flow characteristics of the atmosphere inside the furnace may deteriorate. In addition, the sagging phenomenon of the roller 6 may be aggravated, and the alignment state of the saggers 5 may become poor during transport.

Therefore, the plurality of sagger units 5a may be provided with a first gap. In addition, in the first and second sagger units, the first gap may have a smaller value than a second gap, which is a gap between the ends of the first and second sagger units and the inner side walls 31 of the furnace body 30. The first gap may have a smaller value than the second gap in order to prevent the saggers 5 arranged adjacent to the inner side walls 31 of the furnace body 30 from colliding with the inner side walls 31, to provide uniform thermal energy to the saggers 5 and to take into account the flow characteristics of the internal atmospheric gas. In other words, because the second gap is greater than the first gap, a smooth flow state may be implemented when the atmospheric gas supplied into the inside of the furnace body 30 flows between the inner side walls 31 of the furnace body 30 and the sagger units.

The number of side supply pipes 16 provided on the side of the furnace body 30 may be the same as or less than the column number of saggers 5 to be stacked.

For example, when the column number of saggers 5 is three, the side supply pipe 16 may be provided as three, two, or one. In other words, the number of side supply pipes 16 may not exceed the column number of saggers 5.

In addition, the side supply pipes 16 may be arranged at set positions. The center of a side supply pipe 16 arranged at the topmost area based on the third direction may be placed above the top surface of the sagger or placed on the same plane as the top surface. Accordingly, the gas supplied through the side supply pipe 16 may undergo heat exchange with the material contained in the sagger 5 arranged at the topmost area and may be naturally discharged through the upper discharge pipe 11.

In addition, according to an embodiment in which the saggers 5 are provided in a plurality of columns and a plurality of side supply pipes 16 are also provided in proportion to thereto, each of the side supply pipes 16 may be placed at a set position.

For example, the center of a first side supply pipe placed at the bottom closest to the roller 6 among the plurality of side supply pipes 16 may be arranged at a position corresponding to a sagger 5 located at a first row in the first direction. In addition, the center of a second side supply pipe arranged on the first side supply pipe may be arranged at a position corresponding to a sagger 5 located at a second row in the first direction. In addition, the center of a third side supply pipe arranged on the second side supply pipe and closest to the ceiling surface of the furnace body 30 may be arranged above a sagger 5 located at a third row.

In this case, a distance in the third direction between the bottom surface of the sagger 5 located at the third row and the center of the third side supply pipe may be greater than a distance in the third direction between the bottom surface of the sagger 5 located at the second row and the center of the second side supply pipe.

In addition, a distance in the third direction between the bottom surface of the sagger 5 located at the second row and the center of the third side supply pipe may be greater than a distance in the third direction between the bottom surface of the sagger 5 located at the first row and the center of the second side supply pipe.

Accordingly, even when a plurality of saggers 5 are arranged in a plurality of columns on the roller 6, uniform heat energy may be provided to the saggers 5 and the materials included in the saggers 5, and heat treatment for the plurality of saggers 5 may be simultaneously performed to achieve improved process efficiency.

According to an embodiment, the saggers 5 may be provided with a structure including the first clip 100 connected between adjacent saggers 5 and the second clip 200 connected at the gap between the sagger units 5a, and thus, the alignment of the saggers 5 may be fundamentally prevented from being disturbed when the saggers 5 are transported by the roller 6.

Referring to FIGS. 2 and 3, the first clip 100 and the second clip 200 may be inserted into the furnace body 30 of the heat treatment device. Thus, because foreign materials should not be generated during the heat treatment process, the first clip 100 and the second clip 200 may include a material that is not easily deformed due to temperature. According to an embodiment, the first clip 100 and/or the second clip 200 may include, for example, a ceramic material.

The first clip 100 may include a first clip body 110 in which the lengths of two sides that face each other is greater than the lengths of the remaining two orthogonal sides (e.g., like a rectangle), and a first clip side 120 that is bent at both sides of the first clip body 110 to form both side surfaces.

A first opening 111 of a through-hole structure may be formed in the first clip body 110, and an outer surface of the first clip side 120 may have a first inclined surface 120a that is inclined inwardly by a predetermined angle.

Accordingly, the first clip side 120 may be formed in a triangular shape in which the length in the thickness direction thereof decreases toward a lower part thereof, and the end of the first clip side 120 may be sharply formed so as to have the smallest thickness.

A first insertion space 121 may be formed between the first clip sides 120 formed on both sides of the first clip body 110. The first insertion space 121 may be connected to the first opening 111. When sides 5-1 of a pair of saggers 5 are inserted into the first insertion space 121 and introduced into the inside of the furnace body 30, and when heat from the upper heater 18 and/or the lower heater 19 is transferred to the first clip 100 to heat-treat the material contained in the sagger 5, the heat may be transferred well through the first clip 100 to the sagger 5 and the material contained in the sagger 5.

When the first clip side 120 is not formed to have an inclined surface but is formed to have a vertical surface, because the first clip side 120 has a predetermined thickness, the first clip side 120 may protrude from the side 5-1 of the sagger 5 by the thickness. Therefore, due to the thickness of the first clip side 120, heat from the heater (the upper heater 18 and/or the lower heater 19) may not be properly transferred to the material.

When the first clip side 120 is formed as a vertical surface to have a uniform thickness and has the smallest thickness possible, the sides 5-1 of a pair of saggers 5 may be tightly coupled to each other such that the sides 5-1 of the pair of saggers 5 do not easily come off when being inserted into and connected. In this process, as the first clip side 120 receives a force that causes the first clip side 120 to open, deformation or damage may occur due to stress concentration at the boundary between the first clip side 120 and the first clip body 110.

Furthermore, the first clip 100 may include a ceramic material to prevent contamination due to the generation of foreign materials at high temperatures inside the heat treatment device, and therefore, when the thickness of the first clip side 120 is uniformly small, the possibility of deformation and damage occurring at the boundary between the first clip side 120 and the first clip body 110 may increase.

According to an embodiment, in order to solve this problem, the first inclined surface 120a may be formed such that the thickness of the first clip side 120 decreases toward the end of the first clip side 120, and thus, a boundary portion, which is a connection portion between the first clip side 120 and the first clip body 110, may have a certain thickness. Therefore, the boundary portion may sufficiently withstand stress concentration phenomenon to prevent deformation or damage, and because the thickness of the first clip side 120 decreases toward the end thereof, the heat from the heater may be better conducted to the material through the end of the first clip side 120 and the side 5-1 of the sagger 5.

The first clip sides 120 forming both sides of the first clip 100 may be tightly coupled when the side 5-1 of the sagger 5 is inserted into the first insertion space 121 into which the side 5-1 of the sagger 5 may be inserted.

In addition, referring to FIG. 3, the second clip 200 may include a second clip body 210 in which the lengths of two sides facing each other is greater than the lengths of the remaining two orthogonal sides (e.g., like a rectangle), a second clip side 220 that is bent at both sides of the second clip body 210 to form both side surfaces, and an intermediate insertion member 230 formed between second clip sides 220.

A second opening 211 may be formed through the second clip body 210, and a second insertion space 231 may be formed between the second clip side 220 formed at both sides of the second clip body 210 and the intermediate insertion member 230. The second insertion space 231 may communicate with the second opening 211.

An outer surface of the second clip side 220 may be formed as a second inclined surface 220a that is inclined inwardly by a predetermined angle.

Therefore, the second clip 200 may become thinner toward the end of the second clip side 220 similar to the first clip 100, and thus, when inserted sides 5-1 of a pair of saggers 5 are introduced into the inside of the furnace body 30, deformation and damage at the connection portion between the second clip body 110 and the second clip side 220, which may occur due to tight insertion of the side 5-1 of the sagger 5, may be prevented. In addition, when heat from the upper heater 18 and/or the lower heater 19 is transferred to the first clip 100 to heat-treat the material contained in the sagger 5, the heat may be efficiently transferred through the second clip 200 to the sagger 5 and the material contained in the sagger 5.

The intermediate insertion member 230 may not be formed over the entire length of the second clip side 220, but may be formed only for a portion of the length of the second clip side 220 so that the second opening 211 is provided.

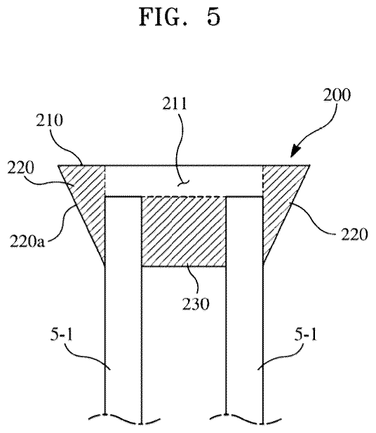

Referring to FIG. 5, the intermediate insertion member 230 may have a widthwise length configured to tightly fit into the gap between the sagger units 5a, and may maintain the gap between the sagger units 5a.

When a pair of first clip sides 120 of the first clip 100 and a pair of second clip side sides 220 of the second clip 200 each face the side of the sagger 5, they may be tightly fitted together and may not easily fall out.

When the first clip 100 and the second clip 200 are fitted into a plurality of saggers 5, the first clip 100 and the second clip 200 may be assembled without protruding further than the tops of the saggers 5.

That is, a concave portion 5-2 may be formed on each side 5-1 of the sagger 5, and therefore, when the first clip 100 and the second clip 200 are fitted into the concave portion 5-2, the first and second clips 100 and 200 may not protrude further than the top of the sagger 5 and may be set to a height that is equal to or less than the top of the sagger 5.

Because the sagger 5 has the concave portion 5-2 and the first clip 100 and the second clip 200 may be fitted into the concave portion 5-1 without protruding, the sagger 5 may be stably loaded without any problem even when stacked in a plurality of columns in the third direction (the z-axis direction).

In addition, because, among the saggers 5 forming the plurality of columns, an upper sagger 5 and a lower sagger 5 may communicate with each other through the concave portion 5-1, the heat treatment gas supplied to the inside of the furnace body 30 may pass through, and thus, the material inside the sagger 5 may be treated more reliably and better during heat treatment.

Furthermore, when the first clip 100 is fitted between the sides of saggers 5 that are in contact with each other, a pair of saggers 5 that are in contact with each other are referred to as a sagger unit 5a, and the second clip 200 is fitted between a plurality of sagger units 5a, a first opening 111 is formed in the first clip body 110 that forms the first clip 100 and a second opening 211 is formed in the second clip body 210 that forms the second clip 200. Therefore, the gas supplied into the furnace body 30 may flow into the gap between the saggers 5, which face each other, and pass through the first opening 111 of the first clip body 110 and the second opening 111 of the second clip body 210 fitted in the gap between the plurality of sagger units 5a.

Even when two saggers 5 face each other, a gap exists between two sides of the two saggers, and gas may flow and pass through the gap.

Therefore, even when the first clip 100 and the second clip 200 are each inserted between the sagger 5 and the sagger unit 5a, the flow of the supplied gas may be prevented from being blocked by the first clip 100 and the second clip 200, and thus, the gas may evenly flow throughout the entire inside of the furnace body 30.

According to an embodiment, by connecting the saggers 5 to each other in contact with each other through the first clip 100, the saggers 5 may be transported in an aligned state without causing any distortion when inside of the furnace body 30.

When a single sagger 5 is transported multiple times, the friction between saggers 5 may increase compared to the case where a plurality of saggers 5 are connected and transported, and when vibration occurs during transport, the vibration may easily cause the saggers to move out of their proper positions and be dislodged.

In addition, because a plurality of sagger units 5a are connected to each other through the second clip 200, the plurality of sagger units 5a forming a row are transported as if one sagger is transported when the plurality of sagger units 5a are transported by the roller 6, and thus, the plurality of sagger units 5a may be transported while maintaining an aligned state.

In addition, because the flow of gas is not blocked by openings formed in the first clip 100 and the second clip 200, communication is smooth, and a material of uniform quality may be obtained by firing without causing hindrance to a heat treatment process inside the heat treatment device.

The features, structures, or effects, described in above embodiments are included in at least one embodiment of the present disclosure and are not necessarily limited to only one embodiment. In addition, the features, structures, or effects, of each embodiment may be combined or modified and implemented in other embodiments by those of ordinary skill in the art to which the embodiments belong. Therefore, the contents related to such combinations and modifications should be interpreted as being included in the scope of the present disclosure.

In addition, although the embodiments have been described above, the embodiments are merely examples and do not limit the present disclosure. Those of ordinary skill in the art to which the present disclosure belongs will understand that various modifications and applications not exemplified above are possible without departing from the essential characteristics of the present embodiments. For example, each component specifically shown in the embodiments may be modified and implemented. In addition, differences related to such modifications and applications should be interpreted as being included in the scope of the present disclosure defined in the appended claims.

The present disclosure may be used in industries that manufacture or use a sagger alignment structure for a heat treatment device.

According to one or more embodiments, when saggers including a material are transported inside a heat treatment device, the saggers are transported by connecting the saggers with a first clip and/or a second clip, and thus, the saggers may not be dislodged and may remain in an aligned state during the transport process.

According to one or more embodiments, the first clip and the second clip may have a first opening and a second opening, respectively, and thus, when the saggers are transferred inside a furnace body forming the heat treatment device in a state in which the saggers are connected, the flow of gas supplied into the furnace body may not be impeded, and contact between the material and the supplied gas may be smoothly achieved.

In addition, each of the clip sides forming the first clip and the second clip according to the present disclosure has an inclined surface so that the thickness of the clip side decreases toward the end thereof, and thus, deformation and damage at a connection portion between a clip body and the clip side due to the connection to the saggers may be prevented, and when heat is transmitted to the material through the first clip and the second clip during heat treatment by a heater, heat may be smoothly transferred.

What is claimed is:

1. A sagger alignment structure comprising:
a first clip configured to connect at least one pair of saggers in a state in which sides of the at least one pair of saggers face each other,
wherein the first clip comprises:
a first clip body;
first clip sides bent from opposite sides of the first clip body; and
a first insertion space between the first clip sides and configured to accommodate the sides of the at least one pair of saggers, and
wherein the first clip body comprises a first opening that defines a through hole through the first clip body.

2. The sagger alignment structure of claim 1, wherein the first clip sides each comprise a first inclined surface on an outer surface thereof, the first inclined surface being inclined inwardly such that a thickness decreases toward an end thereof.

3. The sagger alignment structure of claim 1, wherein a sagger assembly includes the at least one pair of saggers connected by the first clip in the state in which the sides of the at least one pair of saggers face each other,
wherein the sagger alignment structure further comprises a second clip configured to connect at least one pair of the sagger assemblies,
wherein the second clip comprises:
a second clip body;
second clip sides bent from opposite sides of the second clip body;
an intermediate insertion member between the second clip sides and configured to fit into a gap between the at least one pair of the sagger assemblies; and
a second insertion space between the second clip sides and the intermediate insertion member, and configured to accommodate sides of the at least one pair of the sagger assemblies, and
wherein the second clip body comprises a second opening that defines a through hole through the second clip body.

4. The sagger alignment structure of claim 3, wherein the intermediate insertion member is between the second clip sides only on ends of the second clip such that the second opening is not blocked.

5. The sagger alignment structure of claim 3, wherein the second clip sides each comprise a second inclined surface on an outer surface thereof, the second inclined surface being inclined inwardly such that a thickness decreases toward an end thereof.

6. The sagger alignment structure of claim 1, wherein concave portions are formed on the sides of the at least one pair of saggers, and
wherein the first clip is configured to fit into the concave portions of the at least one pair of saggers so as not to protrude from an uppermost side of the at least one pair of saggers.

7. The sagger alignment structure of claim 3, wherein concave portions are formed on the sides of the at least one pair of the sagger assemblies, and
wherein the second clip is configured to fit into the concave portions of the at least one pair of the sagger assemblies so as not to protrude from an uppermost side of the at least one pair of the sagger assemblies.

8. The sagger alignment structure of claim 1, wherein a sagger assembly includes the at least one pair of saggers connected by the first clip in the state in which the sides of the at least one pair of saggers face each other, and
wherein the sagger alignment structure further comprises a second clip configured to connect at least one pair of the sagger assemblies.

9. The sagger alignment structure of claim 1, wherein the first clip is configured to connect the at least one pair of saggers in a contact state in which the sides of the at least one pair of saggers are in contact with each other, to form a sagger assembly, and
wherein the sagger alignment structure further comprises a second clip configured to connect at least one pair of the sagger assemblies at a gap between the at least one pair of the sagger assemblies, the second clip being configured to maintain the at least one pair of the sagger assemblies in at least one line in a first direction.

10. A heat treatment system comprising:
a plurality of saggers configured to contain a material for heat treatment;
a furnace body in which the plurality of saggers are provided, the furnace body comprising a plurality of rollers configured to transport the plurality of saggers, the furnace body being configured to perform a heat treatment on the material contained in the plurality of saggers; and
a sagger alignment structure configured to connect at least some of the plurality of saggers being transported by the plurality of rollers,
wherein the sagger alignment structure comprises:
a first clip configured to connect, among the plurality of saggers, at least one pair of saggers in a state in which sides of the at least one pair of saggers face each other,
wherein the first clip comprises:
a first clip body;
first clip sides bent from opposite sides of the first clip body; and
a first insertion space between the first clip sides and configured to accommodate the sides of the at least one pair of saggers, and
wherein the first clip body comprises a first opening that defines a through hole through the first clip body.

11. The heat treatment system of claim 10, wherein a sagger assembly includes the at least one pair of saggers connected by the first clip in the state in which the sides of the at least one pair of saggers face each other, the at least one pair of saggers being separated by a gap in a first direction,
wherein a plurality of the sagger assemblies are provided in rows in the first direction along a width direction of the furnace body, inside the furnace body,
wherein the sagger alignment structure further comprises a second clip configured to connect at least one pair of the sagger assemblies,
wherein the second clip comprises:
a second clip body;
second clip sides bent from opposite sides of the second clip body;
an intermediate insertion member between the second clip sides and configured to fit into a gap between the at least one pair of the sagger assemblies; and
a second insertion space between the second clip sides and the intermediate insertion member, and configured to accommodate sides of the at least one pair of the sagger assemblies, and
wherein the second clip body comprises a second opening that defines a through hole through the second clip body.

12. A heat treatment system comprising:
a plurality of saggers configured to contain a material for heat treatment;
a furnace body in which the plurality of saggers are provided and comprising a plurality of rollers configured to transport the plurality of saggers, the furnace body being configured to perform a heat treatment on the material contained in the plurality of saggers; and
a sagger alignment structure configured to connect at least some of the plurality of saggers being transported by the plurality of rollers,
wherein the sagger alignment structure comprises:
a first clip configured to connect, among the plurality of saggers, at least one pair of saggers in a state in which sides of the at least one pair of saggers face each other to form a sagger assembly; and
a second clip configured to connect at least one pair of the sagger assemblies, and
wherein a gap between the sagger assemblies is greater than a gap between the at least one pair of saggers.

13. The heat treatment system of claim 12, wherein the first clip comprises:
a first clip body comprising a first opening that defines a through hole;
first clip sides bent from opposite sides of the first clip body; and
a first insertion space between the first clip sides and configured to accommodate the sides of the at least one pair of saggers, and
wherein the second clip comprises:
a second clip body comprising a second opening that defines a through hole;
second clip sides bent from opposite sides of the second clip body;
an intermediate insertion member between the second clip sides and configured to fit into the gap between the at least one pair of the sagger assemblies; and
a second insertion space between the second clip sides and the intermediate insertion member, and configured to accommodate sides of the at least one pair of the sagger assemblies.

14. The heat treatment system of claim 13, wherein a width of the first opening corresponds to the gap between the at least one pair of saggers, and
wherein a width of the second opening corresponds between the gap between the sagger assemblies.

15. The heat treatment system of claim 14, wherein a plurality of the sagger assemblies are provided at intervals in a first direction along a width direction of the furnace body, and
wherein the second clip is connected to the gap between the sagger assemblies, the second clip being configured to maintain an alignment of the plurality of the sagger assemblies provided along the first direction.

16. The heat treatment system of claim 15, wherein the plurality of the sagger assemblies provided at intervals along the first direction each comprise at least one sagger assembly stacked thereon to form a column.

17. The heat treatment system of claim 16, wherein each of the plurality of saggers comprise concave portions on sides thereof, the concave portions being recessed from uppermost side of the plurality of saggers,
wherein the first clip is configured to fit into the concave portions of the at least one pair of saggers so as not to protrude from the uppermost side of the at least one pair of saggers, and
wherein the second clip is configured to fit into the concave portions of the at least one pair of the sagger assemblies so as not to protrude from an upper most side of the at least one pair of the sagger assemblies.

18. The heat treatment system of claim 16, wherein at least one side supply pipe is installed in a side of the furnace body, and
wherein a number of the at least one side supply pipe is equal to or less than a number of sagger assemblies stacked in the column.
